(19) United States
(12) Patent Application Publication
(10) Pub. No.: US 2024/0208446 A1
(43) Pub. Date: Jun. 27, 2024

(54) BUMPER ASSEMBLY WITH CROSSMEMBER

(71) Applicant: BENTELER AUTOMOBILTECHNIK GMBH, Paderborn (DE)

(72) Inventor: Konstantin TATARINOV, Bielefeld (DE)

(21) Appl. No.: 18/545,708

(22) Filed: Dec. 19, 2023

(30) Foreign Application Priority Data
Dec. 22, 2022 (EP) 22216186.1

(51) Int. Cl. B60R 19/18

(52) U.S. Cl. CPC B60R 19/18; B60R 2019/1813

(57) ABSTRACT

The present disclosure relates to a bumper assembly which is coupled to a motor vehicle via crash boxes, comprising a cross member which has, in cross section, a profiled front wall and a profiled rear wall, wherein an unwinding length of the front wall in the vertical direction of the motor vehicle is less than 20%, less than 15% and less than 10% smaller in relation to an unwinding length of the rear wall, but at least both unwinding lengths are equal, and the unwinding length of the front wall is at least more than 1% smaller than the unwinding length of the rear wall.

### RELATED APPLICATIONS

The present application claims priority of European Application Number 22216186.1 filed Dec. 22, 2022, the disclosure of which is hereby incorporated by reference herein in its entirety.

### FIELD

The present disclosure relates to a bumper assembly, which is coupled to a motor vehicle via crash boxes.

### BACKGROUND

Bumper cross members coupled to motor vehicle bodies is done by incorporating crash boxes. A bumper cross member is able to be made of a metallic material and also called a bumper, impact bumper or cross member.

Such a bumper cross member should have sufficient stiffness that a sufficient support effect is achieved, for example, in a pole or pile test. The bumper cross member itself is therefore designed to be as rigid as possible. The motor vehicle hits an object and the crash boxes deform. In this process, crash energy is converted into forming work.

The bumper cross member itself is subject to a conflict of interests, on the one hand in terms of favorable producibility and on the other hand in terms of the task of absorbing energy even through deformation.

At the same time, however, the bumper should have a high degree of stiffness in order, for example, to have such a high resistance to deformation itself in the case of a centrally impacting object, rather than a flat impacting object, i.e., a pile test, that sufficient energy is dissipated during deformation to relieve or protect the crash load paths further downstream, such as the side member, side wall, tunnel and, traction battery boxes.

### SUMMARY

The object of the present disclosure is to provide a bumper cross member or bumper assembly that exhibits improved crash performance, for example, demonstrated in a center pole test.

The aforementioned object is solved according to the disclosure with a bumper assembly.

The bumper assembly is coupled to a motor vehicle via crash boxes, for example, the crash boxes are arranged on a respective longitudinal member of a motor vehicle. The bumper assembly are able to be located at the front of a motor vehicle. However, the bumper assembly is also able to be arranged at the rear of a motor vehicle. The bumper assembly features a cross member. The cross member itself is designed as a hollow profile in its cross section. The cross member has a front wall profiled in cross section and a rear wall profiled in cross section.

A profiled front wall and a profiled rear wall mean that the front wall and the rear wall are not flat in cross section but are machined by forming technology. The profiling of the front wall, as well as the profiling of the rear wall in cross section, means a C-shaped or U-shaped, or hat-shaped profiling. The openings of the C-shape or U-shape or hat-shape are then arranged facing each other, resulting in a hollow profile with a closed cross section.

According to at least one embodiment of the disclosure, the bumper assembly or the cross member is now characterized in that an unwinding length of the front wall oriented in the vertical direction of the motor vehicle is less than 20%, less than 15% and less than 10%, less than 5% smaller, in relation to an unwinding length of the rear wall. However, at least both unwinding lengths, i.e., the unwinding length of the front wall and the unwinding length of the rear wall, are the same. The unwinding length of the front wall is at least more than 1% smaller than the unwinding length of the rear wall, and more than 2% smaller than the unwinding length of the rear wall. The rear wall is also able to be called the back wall. The length ratios mean that the ratio of unwinding length of the front wall to unwinding length of the rear wall is greater than or equal to 0.8 and less than 1. This means that the unwinding length of the front wall is smaller than the unwinding length of the rear wall by a factor greater than or equal to 0.8 and less than 1.

In at least one embodiment of the disclosure in a pile test, for example a center pile test, also called center pole test, the front wall and rear wall of the cross member initially form a sufficient stiffness at an initial impact on the pile. With further intrusion of the pile in the longitudinal direction of the motor vehicle towards the motor vehicle, the cross member then nestles against the cross-sectional contour of the pile. The front wall and the rear wall are moved towards each other in relation to each other. The front wall and rear wall of the cross member then each form a tension band. As the tension band progresses, the pile then enters further in the direction of the motor vehicle and the front wall and rear wall of the cross member wrap around the pile at least lengthwise. The front wall and rear wall thus form a tension band composite.

Due to the approximately equal unwinding length, the cross member is flattened and hardly has to bear any more bending stresses occurring during deformation. As a result, the cross member does not break.

In at least one embodiment of the disclosure the cross member is able to have sufficient stiffness in the event of an impact on the pile. This stiffness is able to be increased by a bead pronounced in the front wall. The bead extends in its longitudinal course, in the transverse direction of the motor vehicle, and is formed at least in longitudinal sections over the cross member. Upon further intrusion of the pile in the direction of the motor vehicle, the cross section is then widened to the motor vehicle vertical direction, in relation to the top and bottom, and, oriented at the depth of the cross-member in the longitudinal direction of the vehicle, pressed flat. The front wall and rear wall thus form a tension band, so that tearing of the front wall or rear wall is prevented in the event of greater intrusion of the pile in the direction of the motor vehicle.

In this context, the unwinding length is defined in such a way that, in the case of a flattened front wall or rear wall, the resulting length is measured in the vertical direction of the vehicle. In this case, the cross member is made from two half shells joined together, from a steel material and as a hot-formed and press-hardened component. However, the cross member is also able to be manufactured in one piece and as a single material, for example from a light metal alloy, for example as an extruded component or as a roll-formed component. For the purposes of the disclosure, the measured unwinding length is the length that results from an upper contact point referred to the vertical direction of the motor vehicle and a lower contact point referred to the vertical direction of the motor vehicle or the respective upper coupling point and lower coupling point. For example, flange parts are able to protrude to the outside, but these are then not to be counted as part of the measured relevant unwinding length.

In at least one embodiment of the disclosure, the front wall and/or the rear wall to be formed as a cross-sectionally hat-shaped profile oriented in the transverse direction of the vehicle, at least in longitudinal sections. The front wall and the rear wall are then coupled to each other via flanges oriented in the vertical direction of the vehicle.

In at least one embodiment of the disclosure, the cross section with unwinding lengths of front wall and rear wall in relation to each other need not be formed over the entire longitudinal course of the cross member, and the cross-sectional geometry is able to be formed between the front wall and the rear wall in a middle longitudinal section of the cross members. For this purpose, a middle longitudinal section is formed in a center cross-sectional plane at Y=0 relative to the transverse direction of the motor vehicle in a range of Y less than or equal to ±250 mm, Y less than or equal to ±210 mm. Therefore, measured in the transverse direction of the motor vehicle, there is a longitudinal section of less than 420 mm, about 400 mm, which in cross section has the design according to the disclosure, but at least ±80 mm, measured again from the center cross-sectional plane at Y=0.

In the outer longitudinal section, for example, a normal cross-sectional geometry is then able to be formed, for example, from a cap plate and a flat or planar strike plate. For example, a hollow section that is not closed in cross section could also be formed in the outer longitudinal section. Consequently, no further striking plate or half shell is required in this area.

The effect according to the disclosure is enhanced by the fact that the cross member is hexagonal in cross section, alternatively and additionally that two wall sections of the profiling are arranged at a respective angle α>91°, greater than 92°, greater than 95°, but less than 180º to one another. Again alternatively or supplementarily, an opening angle between an upper chord and a lower chord of the front wall and/or rear wall >91° is formed. In at least one embodiment of the disclosure, when an obstacle is encountered in the longitudinal direction of the vehicle, for the cross section of the cross member to be deformed in such a way that the cross member is pulled up and down in the vertical direction of the vehicle and the front wall and rear wall are moved towards each other or flattened. This in turn means that the front wall and the rear wall are formed as a respective tension belt.

### BRIEF DESCRIPTION OF THE DRAWINGS

The invention disclosure is described in more detail hereinafter on the basis of exemplary embodiments illustrated in the drawings. In the figures:

FIG. 1 is a bumper assembly in perspective view according to at least one embodiment,

FIG. 2 is a cross section according to section line II-II of FIG. 1 according to at least one embodiment,

FIG. 3 is an unwinding length of front wall and rear wall according to at least one embodiment,

FIG. 4A-FIG. 4E are different cross-sectional variants of the cross member according to at least one embodiment,

FIG. 5 is a top view of a crash scenario according to at least one embodiment,

FIG. 6A and FIG. 6B are a crash scenario at initial impact according to at least one embodiment,

FIG. 7 is a cross-sectional view in the longitudinal direction of the vehicle X according to section line VII-VII from FIG. 5 according to at least one embodiment.

### DETAILED DESCRIPTION

In the figures, the same reference numerals are used for the same and similar components, even if a repeated description is omitted for reasons of simplification.

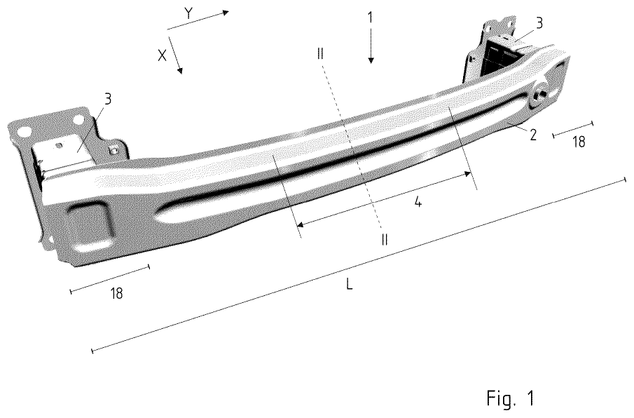

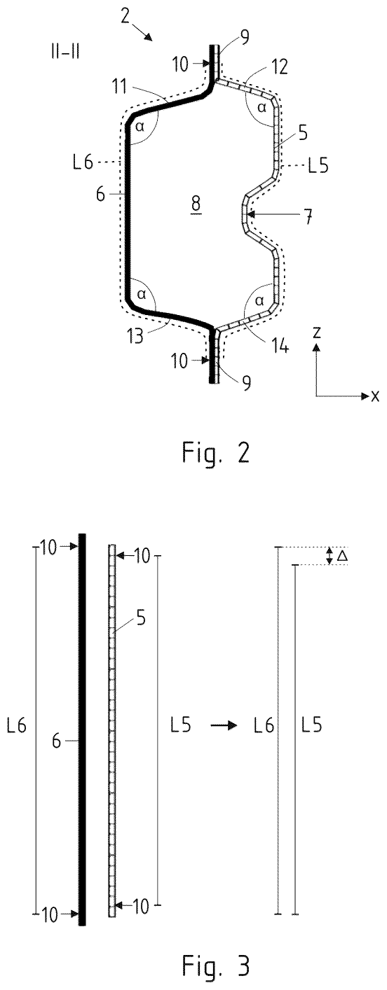

FIG. 1 shows a bumper assembly 1 according to the disclosure in perspective view. The bumper assembly 1 has a cross member 2, wherein the cross member 2 itself is coupled to crash boxes 3 in connection sections 18, and the cross member 2 itself is designed in cross section as a hollow profile, which is discussed in more detail in FIG. 2 and FIG. 3.

The cross member 2 has an overall length L. The length extends in the transverse direction Y of the motor vehicle. The cross-sectional geometry essential to the disclosure is formed only over a middle longitudinal section 4 and not in the connection areas or connection sections 18. However, the cross-sectional geometry is also able to be formed along the entire length of the cross member 2.

According to section line II-II from FIG. 1, a cross section according to the disclosure is shown in FIG. 2. The cross member 2 has a front wall 5 and a rear wall 6. Front wall 5 and rear wall 6 in this case refer to the longitudinal direction of the motor vehicle X as the direction of travel. The cross member 2 has a bead 7 in the front wall 5. The bead 7 is arranged opposite to the longitudinal direction of the motor vehicle X in an interior 8 of the hollow profile of the cross member 2. The bead 7 extends in its longitudinal direction as shown in FIG. 1, but in this case does not extend into the connection sections 18, at least longitudinally along the length L of the cross member 2.

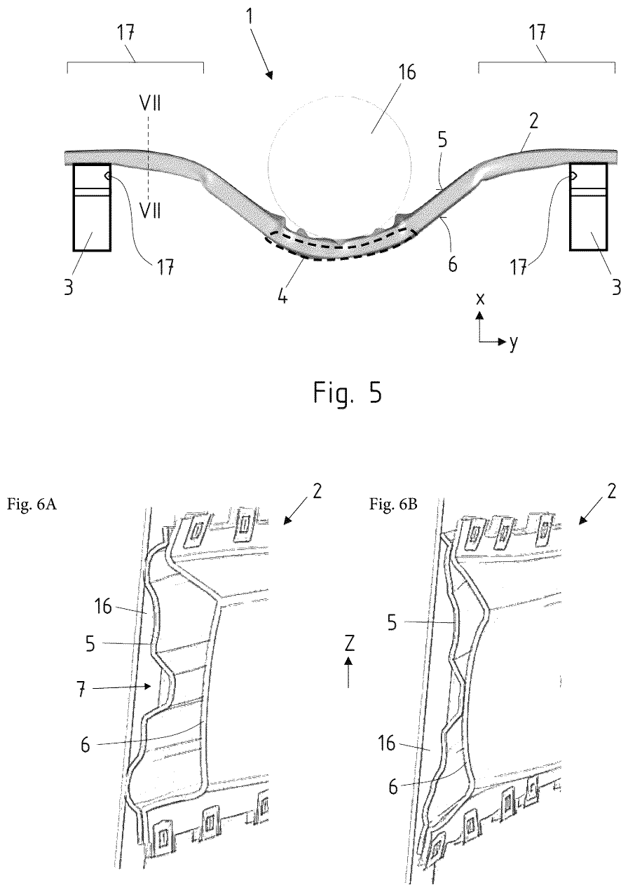

Both front wall 5 and rear wall 6 each have flanges 9 oriented in the vertical direction of the vehicle z. As an example, a coupling point 10, for example a spot weld at reference numeral 10, is shown at the height of the vertical direction of the vehicle. The unwinding length according to the disclosure is now the length measured along the profiled cross section of the front wall 5 or rear wall 6 and here specifically from the upper coupling point 10 relative to the image plane to the lower coupling point 10 relative to the image plane. If front wall 5 and rear wall 6 are pressed flat, the view from the respective upper coupling point 10 to the lower coupling point 10 shown in FIG. 3 is obtained. The unwinding length L6 of the rear wall 6 is slightly greater than the unwinding length L5 of the front wall. This results in a correspondingly low delta A. In accordance with the disclosure, this ensures that neither the front wall 5 nor the rear wall 6 nor the joint as a tension member will tear when the cross member 2 bends or nestles around a pile 16 as shown, for example, in FIG. 5. In the crash case, the front wall 5 and rear wall 6 are approximately adjacent to each other with a zero gap. However, this is shown here on the image plane to the left and right separated from each other for better illustration. The delta, i.e., the difference in the unwinding length, is based on the mechanical property value of the elongation at break of the material used.

Thus, the delta lies in a range in which the material stretches elastically before starting to crack.

As shown in FIG. 2, both the profile cross section of the front wall 5 and the profile cross section of the rear wall 6 each have a hat-shaped configuration. The respective openings of the hat shape are oriented towards each other and thus form the interior 8, of the hollow profile closed in cross section. Furthermore, both front wall 5 and rear wall 6 have a respective upper chord 11, 12 and a respective lower chord 13, 14. A respective angle α from the top flange 11 of the rear wall 6 to the web of the rear wall 6 or top flange 12 of the front wall 5 to the web of the front wall 5 or from the bottom flange 13 of the rear wall 6 to the web of the rear wall 6 or bottom flange 14 of the front wall 5 to the web of the front wall 5 angle α is greater than 95°. In the event of a crash in the longitudinal direction of the vehicle X, the front wall 5 and rear wall 6 are stretched or pulled upwards and downwards in relation to the vertical direction of the vehicle Z, resulting in flattening of the front wall 5 and rear wall 6 in relation to each other in the longitudinal direction of the vehicle X.

In at least one embodiment of the disclosure, the respective upper chord 11, 12 of rear wall 6 and front wall 5 and the respective lower chord 13, 14 of front wall 5 and rear wall 6 extend in the middle section in the longitudinal direction X of the motor vehicle by at least 10 mm, more than 15 mm, more than 20 mm. The upper and lower chords should not extend more than 100 mm in each case in the longitudinal direction X of the vehicle. The upper chord 11 and the lower chord 13 of the rear wall 6 and the upper chord 12 and the lower chord 14 of the front wall 5 are formed with approximately the same or similar extension in the longitudinal direction X of the vehicle. At most, the extensions in the longitudinal direction X of the motor vehicle of upper chord 11, 12 and lower chord 13, 14 should deviate from each other by less than 40%, from upper chord/rear wall to upper chord/front wall and from lower chord/rear wall to lower chord/front wall by a maximum of 40%, less than 30% and less than 25%.

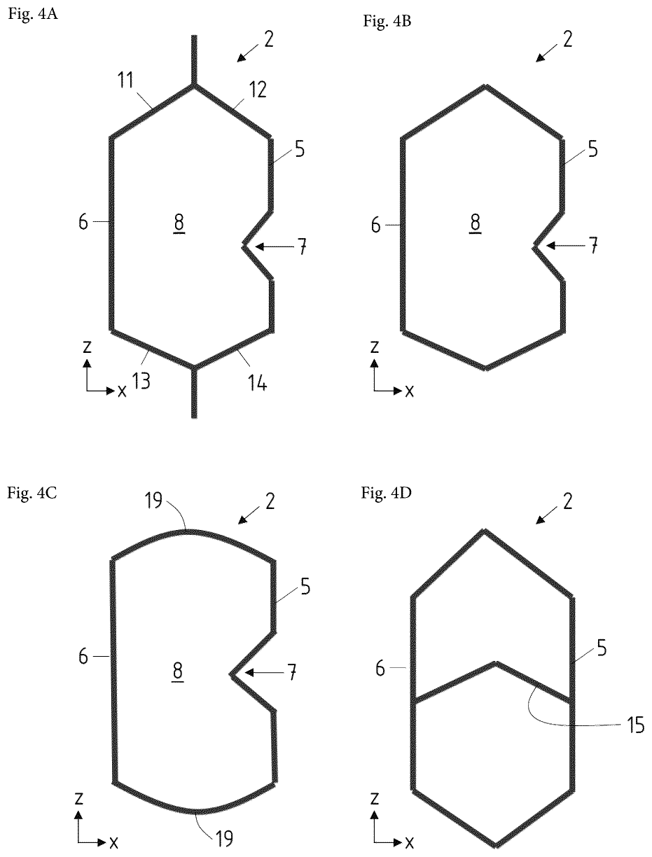

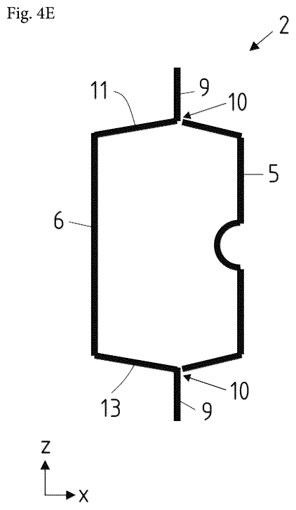

FIG. 4A and FIG. 4D show different cross-sectional variants of the cross member 2 according to the disclosure, at least in the middle longitudinal section 4. The cross member 2 itself is always hollow and has an interior. The upper chord 11, 12 and lower chord 13, 14 of the front wall 5 and rear wall 6, as viewed from one another, are always arranged facing outward in the vertical direction of the vehicle Z or pointing outward in the shape of a hood or roof. In the event of a crash in the longitudinal direction of the vehicle X, this ensures that the front wall 5 and rear wall 6 are pulled outwards towards each other in an upward and downward direction in relation to the vertical direction Z of the vehicle. This is able to be shown in cross section as a hexagonal geometry in each case, in the case of FIG. 4A, FIG. 4B, and FIG. 4D. However, two outward curvatures or roundings 19 are able to be formed therewith as shown in FIG. 4C. A center web 15 is also able to be arranged as shown in FIG. 4D. However, this then also has a cross-sectional geometry such that is deformable in the longitudinal direction of the motor vehicle X to the vertical direction of the motor vehicle during intrusion, so that together with the front wall and rear wall a tensile composite that is as flat as possible is able to be formed.

FIG. 4E shows a further embodiment. Here, the rear wall 6 has the cross section of a hat profile with protruding flanges. The front wall 5 is coupled as a W-shaped or omega-shaped plate. However, this has no flanges. The coupling points 10 are thus not coupled in the flanges 9 themselves, but at the transition between upper chord 11 and lower chord 13 to flange 9 of the rear wall 6. Here, for example, laser-welded quilted seams or MIG/MAG welding processes is able to be used.

A plan view of the crash scenario according to the disclosure is shown in FIG. 5. A pile 16 penetrates the motor vehicle, which is not shown in greater detail, in the longitudinal direction X of the motor vehicle. This causes the cross member 2 to deform and its longitudinal section to hug the contour of the pile 16, such as in the middle longitudinal section. The front wall 5 and the rear wall 6 are moved towards each other, at least in the longitudinal section, and serve as a tension band so that neither the front wall 5 nor the rear wall 6 is torn off. To enhance the effect, internal beads 7 are able to be arranged on the crash boxes 3 so that the beads 7 deform inwardly toward the transverse direction of the motor vehicle Y, thus promoting a further tension band characteristic of front wall 5 and rear wall 6 moving toward each other.

FIG. 6A and FIG. 6B show the crash scenario according to the disclosure at initial impact as well as progressive impact. The pile 16 first collides with the front wall 5 of the cross member 2. This initially deforms the front wall. As the entry progresses, the cross member 2 is stretched or flattened in the vertical direction of the vehicle Z upwards and downwards in relation to the image plane due to the pile 16, so that the front wall 5 and also the rear wall 6 are pulled or stretched in the vertical direction Z of the vehicle. The front wall 5 is slightly smaller in its unwinding length than the rear wall 6. With increasing deformation in the vertical direction of the vehicle Z as shown in FIG. 6B and progressive deformation as shown in FIG. 5, controlled tension band behavior is thus achieved without front wall 5 and rear wall 6 deforming uncontrollably from one another in such a way that one of the two walls tears, due to the defined unwinding length according to the disclosure and the resulting small “lever” or distance between the front impact surface and the rear wall subjected to the greatest tensile stress. In the middle section, failure of the rear wall is able to be reliably prevented without costly measures such as locally more ductile material properties or reinforcing patches. In the further course of the crash or intrusion, the front wall and rear wall are able to be pushed together even further and come to rest directly on top of each other so that a tensile composite is formed as a double sheet layer.

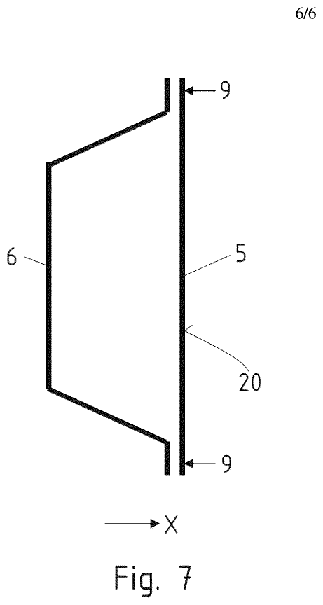

FIG. 7 shows a cross-sectional view in the longitudinal direction of the vehicle X along section line VII-VII from FIG. 5. The relation according to the disclosure between the unwinding length of front wall 5 and the unwinding length of rear wall 6 in connection with the respective profiling of front wall 5 and rear wall 6 relative to each other is only formed in the middle longitudinal section. In the outer longitudinal sections, the front wall 5 is designed as a flat strike plate and the rear wall 6 as a hat-shaped profile. The impact area for objects oriented forwards in the longitudinal direction of the vehicle X or an impact scenario with partial overlap is thus increased, due to the fact that the outer area of the flanges 9 also serves as the front impact area. Thus, the bumper assembly 1 according to the disclosure is also fulfill further crash scenarios, for example a crash scenario with partial overlap and/or a barrier test with respect to the crash conditions.

1-12. (canceled)

13. A bumper assembly coupled to a motor vehicle via crash boxes, the bumper assembly comprising:
at least one cross member comprising connection sections for the crash boxes and a middle longitudinal section between the at least one crossmember and the crash boxes, wherein the cross member comprises, in cross section, a profiled front wall and a profiled rear wall, and in the middle longitudinal section is an unwinding length of the front wall less than 20% smaller than an unwinding length of the rear wall.

14. The bumper assembly according to claim 13, wherein the profiling of the front wall and the rear wall in the middle longitudinal section is C-shaped or hat-shaped, respectively, in cross section, and the openings of the C or hat shape are face each other.

15. The bumper assembly according to claim 13, wherein the cross member comprises two profiled half-shells joined together.

16. The bumper assembly according to claim 13, wherein the cross member comprises a steel material.

17. The bumper assembly according to claim 13, wherein the unwinding length is measured, relative to a vertical direction of the motor vehicle, from an upper coupling point between the front wall and the rear wall to a lower coupling point.

18. The bumper assembly according to claim 13, wherein the front wall and the rear wall comprise a profile with a hat-shaped cross section at least with regard to the longitudinal section.

19. The bumper assembly according to claim 13, wherein the unwinding length is only in the middle longitudinal section, relative to a transverse direction of the motor vehicle.

20. The bumper assembly according to claim 13, wherein the front wall comprises a bead which extends in its longitudinal direction in a transverse direction of the motor vehicle at least in the middle longitudinal section.

21. The bumper assembly according to claim 13, wherein the cross section of the cross member is hexagonal in the central longitudinal section.

22. The bumper assembly according to claim 13, wherein an opening angle between an upper chord and a lower chord of the front wall or the rear wall is greater than 95°.

23. The bumper assembly according to claim 17, wherein, in cross-section, the front wall in the connection section comprises a straight line from an upper coupling point to a lower coupling point and comprises a flat impact surface.

24. The bumper assembly according to claim 13, wherein at least both unwinding lengths are equal.

25. The bumper assembly according to claim 13, wherein in the middle longitudinal section is an unwinding length of the front wall less than 15% smaller than an unwinding length of the rear wall

26. The bumper assembly according to claim 13, wherein in the middle longitudinal section is an unwinding length of the front wall less than 10% smaller than an unwinding length of the rear wall

27. The bumper assembly according to claim 13, wherein the cross member comprises one piece of a single material.

28. The bumper assembly according to claim 13, wherein the cross member comprises at least one half-shell which is hot formed and press hardened.

29. The bumper assembly according to claim 13, wherein the cross member comprises a light metal material.

30. The bumper assembly according to claim 13, wherein the front wall and rear wall are coupled with each other via flanges oriented in a vertical direction of the motor vehicle.

31. The bumper assembly according to claim 13, wherein the unwinding length is only in the middle longitudinal section, relative to a transverse direction of the motor vehicle, and in a range from a center cross-sectional plane less than or equal to ±250 mm.

32. The bumper assembly according to claim 13, wherein the unwinding length is only in the middle longitudinal section, relative to a transverse direction of the motor vehicle, and in a range from a center cross-sectional plane less than or equal to ±210 mm.

33. The bumper assembly according to claim 13, wherein the unwinding length is only in the middle longitudinal section, relative to a transverse direction of the motor vehicle, and in a range from a center cross-sectional plane less than or equal to ±80 mm.

34. The bumper assembly according to claim 13, wherein the profiled front wall and the profiled rear wall are arranged at an angle greater than 95° to one another.

35. The bumper assembly according to claim 13, wherein the unwinding length of the front wall is by at least more than 1% smaller than the unwinding length of the rear wall.
